(19) United States
(12) Patent Application Publication
(10) Pub. No.: US 2013/0272095 A1
(43) Pub. Date: Oct. 17, 2013

(54) INTEGRATED AUDIO-VISUAL ACOUSTIC DETECTION

(71) Applicants: Adrian S. Brown, Salisbury (GB); Samantha Dugelay, Salisbury (GB); Duncan Paul Williams, Salisbury (GB); Shannon Goffin, Salisbury (GB)

(72) Inventors: Adrian S. Brown, Salisbury (GB); Samantha Dugelay, Salisbury (GB); Duncan Paul Williams, Salisbury (GB); Shannon Goffin, Salisbury (GB)

(21) Appl. No.: 13/825,331

(22) PCT Filed: Sep. 29, 2011
(86) PCT No.: PCT/GB11/01407

§ 371 Date: Jun. 24, 2013

(30) Foreign Application Priority Data
Sep. 29, 2010 (GB) 1016352.5

(51) Int. Cl. G01S 3/80

(52) U.S. Cl. CPC G01S 3/80
USPC 367/118

(57) ABSTRACT

The present invention relates to a method and associated apparatus for the detection and identification of a sound event comprising collecting audio data from an acoustic sensor; processing the collected audio data to determine periodicity of the sound, processing the collected audio data to isolate transient and/or non-linear sounds and processing the collected audio data to identify frequency modulated pulses, in parallel to produce three output data sets; and combining and comparing the output data sets to categorise the sound event as being mechanical, biological or environmental. The method is particularly useful for detecting and analysing sound events in real time or near real-time and, in particular, for sonar applications as well as ground (including seismic) monitoring or for monitoring sound events in air (e.g. noise pollution).

The present invention relates to acoustic detection systems and a method for processing and integrating audio and visual outputs of such detection systems. The method of the invention is particularly useful for sonar applications and, consequently, the invention also relates to sonar systems which comprise integrated audio and visual outputs.

In many types of acoustic detection, an acoustic event is presented or displayed visually to an operator who is then responsible for detecting the presence and identity of the event using this visual information. Whilst detection of large, static events may be readily determined from visual images alone, it is often the case that visual analysis of an acoustic event is less effective if the event is transient. Such events are more likely to be detected by an auditory display and operators typically rely on listening to identify the source of the event. Thus, many acoustic detection systems rely on a combined auditory and visual analysis of the detector output. Whilst this demonstrates the excellent ability of the human auditory system to detect and identify transient sounds in the presence of noise, it nevertheless has the disadvantages that it is subjective and requires highly skilled and trained personnel.

This is particularly true in the field of sonar, where acoustic detection may be facilitated by huge numbers of acoustic detectors. For example, submarine sonar systems usually comprise a number of different hydrophone arrays which, in theory, can be arranged in any orientation and on any part of the submarine. A typical submarine will have a number of arrays with hydrophone elements ranging from a single hydrophone, to line arrays and complex arrays of many hundreds or even thousands of hydrophone elements.

Collectively the large numbers of acoustic detectors commonly used produce a staggering amount of audio data for processing. Submarine sonar systems typically collect vastly more data than operators are able to analyse in real time; whilst many sound events, such as hull popping or an explosion might be very readily identified, many other types of sound are routinely only identified with post-event analysis.

This places an additional burden on the operator and as the potential for newer more effective acoustic detector is realised, the workload of the operators may increase to a point which is unmanageable.

Ideally, auditory analysis would be replaced, or at the very least be complemented by, automatic digital processing of the data collected by the acoustic sensor to reduce the burden on the operator and create the potential for complete real-time monitoring of sound events.

Auditory-visual processing has been developed in other applications, for example, in speech recognition [G. Potamianos, C. Neti, G. Gravier, A. Garg and A. W. Senior, “Recent advances in the automatic recognition of audiovisual speech,” Proc. IEEE, pp 1306-1326, 2003.] and whilst there has been success in combining audio and video features, a generalised procedure is still lacking. Different authors (e.g. M. Liu and T. Huang, “Video based person authentication via audio/visual association,” Proc. ICME, pp 553-556, 2006) have advocated that the features are combined at different stages (early or late) in the processing scheme but, in general, it is first necessary to characterise (and extract) features that capture the relevant auditory and visual information.

Despite these advances, it appears that, to date, there is no effective way to automate this integration of auditory and visual information as part of the system display.

Accordingly, the present inventors have created a system which demonstrates how features can be extracted from collected audio data in such as way as to identify different sources of noise. The invention has the capability to digitally process collected audio data in such as way as to discriminate between transient noise, chirps or frequency modulated pulses and rhythmic sounds. Digital processing means that the invention has the potential to operate in real time and thus provide an operator with an objective assessment of the origin of a sound, which may be used to complement the operator's auditory analysis and may even allow for complete automation of the acoustic sensor system and thereby provide the ability to detect and identify and discriminate between sound events, in real time, without the requirement for human intervention. This has clear benefits in terms of reducing operator burden and potentially, numbers of personnel required which may be of considerable value where space is restricted e.g. in a submarine.

Accordingly, in a first aspect the present invention provides a method for the detection and identification of a sound event comprising:
collecting audio data from an acoustic sensor;
processing the collected audio data to determine periodicity of the sound, processing the collected audio data to isolate transient and/or non-linear sounds and processing the collected audio data to identify frequency modulated pulses, in parallel to produce three output data sets; and
combining and comparing the output data sets to categorise the sound event as being mechanical, biological or environmental.

The method is suitable for collecting and processing data obtained from a single acoustic sensor but is equally well suited to collecting and processing audio data which has been collected from an array of acoustic sensors. Such arrays are well known in the art and it will be well understood by the skilled person that the data obtained from such arrays may additionally be subjected to techniques such as beam forming as is standard in the art to change and/or improve directionality of the sensor array.

The method is suitable for both passive and active sound detection, although a particular advantage of the invention is the ability to process large volumes of sound data in “listening mode” i.e. passive detection. Preferably, therefore, the method utilises audio data collected from a passive acoustic sensor.

Such acoustic sensors are well known in the art and, consequently, the method is useful for any application in which passive sound detection is required e.g. in sonar or ground monitoring applications or in monitoring levels of noise pollution. Thus the acoustic data may be collected from acoustic sensors such as a hydrophone, a microphone, a geophone or an ionophone.

The method of the invention is particularly useful in sonar applications, i.e. wherein the acoustic sensor is a hydrophone. The method may be applied in real time on each source of data, and thus has the potential for real-time or near real-time processing of sonar data. This is particularly beneficial as it can provide the sonar operator with a very rapid visual representation of the collected audio data which can be simply and quickly annotated as mechanical, biological or environmental. Methods for annotation of the processed data will be apparent to those skilled in the art but, conveniently, different colours, or graphics, may be applied to each of the three sound types. This can aid the sonar operator's decision making by helping prioritising which features/sounds require further investigation and/or auditory analysis. In sonar, and indeed in other applications, the method has the potential to provide fully automated detection and characterisation of sound events, which may be useful when trained operators are not available or are engaged with other tasks.

Without wishing to be bound by theory, it appears that the method is not limited by audio frequency. However, it is preferred that the method is applied to audio data collected over a frequency range of from about 1.5 kHz to 16 kHz. Below 1.5 kHz, directionality may be distorted or lost and, although there is no theoretical reason why the method will not function with sound frequencies above 16 kHz, conveniently, operating below 16 kHz can be beneficial as it affords the operator the option to confirm sound events with auditory analysis (listening). Of course, it will be well understood that the ideal frequency range will be determined by the application to which the method is applied and by the sheer volumes of data that are required to be collected but conveniently, the method is applied to sound frequencies in the range of from about 2 to 12 kHz and more preferably from about 3 to 6 kHz.

The method relies upon triplicate parallel processing of the collected audio data, which enables classification of the sound into one of the three categories; mechanical, biological and environmental. The inventors have found that analysis of different signal types shows that signals of different types produced different responses to processing but that discrimination between signal types is obtained on application of three parallel processing steps. The three processing steps may be conducted in any order provided they are all performed on the collected audio data i.e. the processing may be done in parallel (whether at the same time or not) but not in series.

The first of the processing steps is to determine periodicity of the collected audio data. Sound events of periodic or repetitive nature will be easily detected by this step, which is particularly useful for identifying regular mechanical sounds, such as ship engines, drilling equipment, wind turbines etc. Suitable algorithms for determining periodicity are known in the art, for example, Pitch Period Estimation, Pitch Detection Algorithm and Frequency Determination Algorithms. In a preferred embodiment of the invention the periodicity of the sound is determined by subjecting the collected audio data to Normalised Square Difference Function. The Normalised Square Difference Function (NSDF) has been used successfully to detect and determine the pitch of a violin and needs only two periods of a waveform to within a window to produce a good estimation of the period.

The ability of the NSDF to discriminate rhythmic sounds in the types of application considered here (e.g. sonar etc) is surprising as hitherto its main application has been in the analysis of music. Nevertheless, the present inventors have found that this algorithm is particularly powerful in identifying rhythmic noise within sound events.

The NSDF may be defined as follows: The Square Difference Function (SDF) is defined as:

$${d}_{t} ( τ ) = {\sum }_{j = t}^{t + W - 1} {( {x}_{j} - {x}_{j + τ} )}^{2} ,$$

where x is the signal, W is the window size, and τ is the lag. The SDF can be rewritten as:

$${d}_{t} ( τ ) = {m}_{t} ( τ ) - 2 {r}_{t} ( τ ) , \\ where \text{:} {m}_{t} ( τ ) = {\sum }_{j = t}^{t + W - 1} ( {x}_{j}^{2} + {x}_{j + τ}^{2} ) and {r}_{t} ( τ ) = {\sum }_{j = t}^{t + W - 1} {x}_{j} {x}_{j + τ} .$$

The Normalised SDF is then:

$$\begin{matrix}{n}_{t} ( τ ) = 1 - \frac{{m}_{t} ( τ ) - 2 {r}_{t} ( τ )}{{m}_{t} ( τ )} \\ = \frac{2 {r}_{t} ( τ )}{{m}_{t} ( τ )} .\end{matrix}$$

The greatest possible magnitude of 2rₜ(τ) is mₜ(τ) i.e. |2rₜ(τ)|≦mₜ(τ) This puts nₜ(τ) in the range of −1 to 1, where 1 means perfect correlation, 0 means no correlation and −1 means perfect negative correlation, irrespective of the waveform's amplitude.

Local maxima in the correlation coefficients at integer τ potentially represent the period associated with the pitch. However some local maxima are spurious. Key maxima are chosen as the highest maximum between every positively sloped zero crossing and negatively sloped zero crossing. We start from the first positively sloped zero crossing. If there is a positively sloped zero crossing toward the end without a negative zero crossing, the highest maximum so far is accepted, if one exists.

The second of the processing steps is to isolate transient and/or non-linear sounds from the collected audio data (although it will be understood that the order of the processing steps is arbitrary). Algorithms for detecting transient or non-linear events are known in the art but a preferred algorithm is the Hilbert-Huang Transform.

The Hilbert Huang transform is the successive combination of the empirical mode decomposition and the Hilbert transform. This leads to a highly efficient tool for the investigation of transient and nonlinear features. Applications of the HHT include materials damage detection and biomedical monitoring.

The Empirical Mode Decomposition (EMD) is a general nonlinear non-stationary signal decomposition method. The aim of the EMD is to decompose the signal into a sum of Intrinsic Mode Functions (IMFs). An IMF is defined as a function that satisfies two conditions:
1. the number of extrema and the number of zero crossings must be either equal or differ at most by one, and
2. at any point, the mean value of the envelope defined by the local maxima and the envelope defined by the local minima must be zero (or close to zero).

The major advantage of the EMD is that the IMFs are derived directly from the signal itself and does not require any a priori known basis. Hence, the analysis is adaptive, in contrast to Fourier or Wavelet analysis, where the signal is decomposed in a linear combination of predefined basis functions.

Given a signal x(t), the algorithm of the EMD can be summarized as follows:
1. Local maxima and minima of d₀(t)=x(t)
2. Interpolate between the maxima and minima in order to obtain the upper and lower envelopes eᵤ(t) and eₗ(t) respectively.
3. Compute the mean of the envelopes m(t)=(eᵤ(t)+eₗ(t))/2
4. Extract the detail d₁(t)=d₀(t)−m(t)
5. Iterate steps 1-4 on the residual until the detail signal dₖ(t) can be considered an IMF: c₁(t)=dₖ(t)
6. Iterate steps 1-5 on the residual rₙ(t)=x(t)−cₙ(t) in order to obtain all the IMFs c₁(t), . . . , cₙ(t) of the signal.

The procedure terminates when the residual cₙ(t) is a constant, a monotonic slope, or a function with only one extrema. The result of the EMD process produces N IMFs c₁(t), . . . , c_{N} (t) and a residue signal r_{N}(t):

$$x ( t ) = {\sum }_{n = 1}^{N} {c}_{n} ( t ) + {r}_{n} ( t )$$

The lower order IMFs capture fast oscillation modes of the signal, while the higher order IMFs capture the slow oscillation modes.

The IMFs have a vertically symmetric and narrowband form that allow the second step of the Huang-Hilbert to be applied: the Hilbert transform of each IMF. As explained below, the Hilbert transform obtains the best fit of a sinusoid to each IMF at every point in time, identifying an instantaneous frequency (IF), along with its associated instantaneous amplitude (IA). The IF and IA provide a time-frequency decomposition of the data that is highly effective at resolving non-linear and transient features.

The IF is generally obtained from the phase of a complex signal z(t) which is constructed by analytical continuation of the real signal x(t) onto the complex plane. By definition, the analytic signal is:

z(t)=x(t)+iy(t)

Where y(t) is given by the Hilbert Transform:

$$y ( t ) = \frac{1}{π} P {\int }_{- ∞}^{+ ∞} \frac{x ( {t}^{′} )}{t - {t}^{′}} d {t}^{′}$$

(Here P denotes the principal Cauchy value.) The amplitude and phase of the analytic signal are defined in the usual manner: α(t)=|z(t)| and θ(t)=arg [z(t)].

The analytic signal represents the time-series as a slowly varying amplitude envelope modulating a faster varying phase function. The IF is then given by ω(t)=dθ(t)/dt, while the IA is α(t). We emphasize that the IF, a function of time, has a very different meaning from the Fourier frequency, which is constant across the data record being transformed. Indeed, as the IF is a continuous function, it may express a modulation of a base frequency over a small fraction of the base wave-cycle.

The third processing step of the method of the invention is selected to identify frequency modulated pulses. Any known method of identifying frequency modulated pulses may be employed but, in a preferred embodiment frequency modulated pulse within the collected audio data are determined by applying a Fractional Fourier Transform to the collected data.

The fractional Fourier transform (FRFT) is the generalization of the classical Fourier transform (FT). It depends on a parameter α and can be interpreted as a rotation by an angle α in the time-frequency plane or decomposition of the signal in terms of chirps.

The properties and applications of the conventional FT are special cases of those of the FRFT. FT of a function can be considered as a linear differential operator acting on that function. The FRFT generalizes this differential operator by letting it depend on a continuous parameter α. Mathematically, αth order FRFT is the αth power of FT operator.

The FRFT of a function s(x) can be given as:

$$\begin{matrix}{F}^{a} [ s ( x ) ] = S ( ω ) \\ = \frac{exp ( - i ( \frac{π}{4} - \frac{α}{2} ) )}{\sqrt{2 π sin α}} exp ( - \frac{i}{2} {ω}^{2} cot α ) \\ \int exp ( - \frac{i}{2} {x}^{2} cot α - \frac{i x ω}{sin α} ) s ( x ) d x\end{matrix}$$

### Where α=απ/2

The FRFT of a function is equivalent to a four-step process:
1. Multiplying the function with a chirp,
2. Taking its Fourier transform,
3. Again multiplying with a chirp, and
4. Then multiplication with an amplitude factor.

The above-described type of FRFT is also known as Chirp FRFT (CFRFT). In this project, because of the nature of the Chirp FRFT, this approach is used to locate biological noise as this acts as a chirp match filter.

The algorithms selected for processing the data are particularly useful in extracting and discriminating the responses of an acoustic sensor. The combination of the three algorithms provide the ability to discriminate between types of sound and the above examples are particularly convenient because they demonstrate good performance on short samples of data.

The present inventors have demonstrated the potential of the above three algorithms to discriminate different types of sonar response as being attributable to mechanical, biological or environmental sources. The particular combination of the three algorithms running in parallel provides a further advantage in that biological noise may be further characterised as frequency modulated pulses or impulsive clicks.

The output data sets may then be combined and compared to categorise the sound event as being mechanical, biological or environmental. This may be achieved by simple visual comparison or by extracting output features and presenting in a feature vector for comparison.

Alternatively, the combined output data sets are compared with data sets obtained from pre-determined sound events. These may be obtained by processing data collected from known (or control) noise sources, the outputs of which can be used to create a comparison library from which a rapid identification may be made by comparing with the combined outputs from an unknown sound event.

The approach exemplified herein divides sonar time series data into regular “chunks” and then applies the algorithms to each chunk in parallel. The output of the algorithm can then be plotted as an output level as a function of time or frequency for each chunk.

Once extracted, the output data sets may be combined to allow for comparison of the outputs or fused to give a visual representation of the audio data collected and processed. Conveniently, this may be overlayed with the broadband passive sonar image which is the standard visual representation of the sonar data collected to aid analysis. Different categories of sound may be represented by a different graphic or colour scheme.

In an second aspect, the present invention also provides an apparatus for the detection and identification of a sound event comprising:
an acoustic sensor;
means for collecting audio data from the acoustic sensor;
processing means adapted for parallel processing of the collected audio data to determine periodicity of the sound, to isolate transient and/or non-linear sounds and to identify frequency modulated pulses, to produce output data sets;
means for combining and comparing the output data sets; and
display means for displaying and distinguishing the output data sets and the collected audio data.

Conveniently the apparatus comprises an array of acoustic sensors, which may be formed in any format as is required or as is standard in the relevant application, for example, a single sensor may be sufficient or many sensors may be required or may be of particular use. Arrays of sensors are known in the art and may be arranged in any format, such as line arrays, conventional matrix arrays or in complex patterns and arrangements which maximises the collection of data from a particular location or direction.

For most applications it will not be necessary that the sensor is active or is measuring response to an initial or incident signal. Consequently, it is preferred that the acoustic sensor is a passive acoustic sensor.

The acoustic sensor may be any type which is capable of detecting sound, as are well known in the art. Preferred sensor types include, but are not limited to, hydrophones, microphones, geophones and ionophones.

A particularly preferred acoustic sensor is a hydrophone, which finds common use in sonar applications. Sonar hydrophone systems range from single hydrophones to line arrays to complicated arrays of particular shape which may be used on the surface of vessels or trailed behind the vessel. Thus, a particularly preferred application of the apparatus of the invention is as a sonar system and even more preferred a sonar system for use in submarines. The skilled person will understand, however, that the same apparatus may be readily adapted for any listening activity including, for example, monitoring the biological effects of changing shipping lanes and undersea activity such as oil exploration or, through the use of a geophone, for listening to ground activity, for example to detection transient or unusual seismic activity, which may be useful in the early detection of earthquakes or the monitoring of earthquake fault lines.

In view of the fact that the apparatus has the potential to replace or augment human hearing, it is preferred that the sensor operates over the entire frequency that is audible to the human ear and, preferably, at those frequencies where directional information may also be obtained. Thus it is preferred that the acoustic sensor operates in the frequency range of from about 1.5 kHz to 16 kHz, preferably in the range of from about 2 to 12 kHz and more preferably from about 3 to 6 kHz.

Broadband passive acoustic sensors, such as broadband hydrophone arrays, which operate over the 3 to 6 kHz frequency range are well known in the art and the theory whereby such sensors collect audio data is well known.

After collection of the audio data, the data is processed to ensure it is provided in digital form for further analysis. Accordingly the means for collecting audio data in the apparatus is an analogue to digital converter (ADC). The ADC may be a separate component within the apparatus or may be an integral part of the acoustic sensor.

Once collected and converted to digital form, the data is then processed in parallel using the mathematical transformations discussed above. Conveniently, the processing means may be a standard microcomputer programmed to perform the mathematical transformations on the data in parallel and then combine, integrate or fuse the output data sets to provide a visual output which clearly discriminates between mechanical, biological and environmental noises. This may be done by simply providing each output in a different colour to enable immediate identification and classification by the operator. In a preferred embodiment the computer is programmed to run the algorithms in real time, on the data collected from every individual sensor, or may be programmed to process data from any particular sensor or groups of sensors.

The apparatus enables detection, identification and classification of a sound event as described above. In a preferred embodiment, the means for combining and comparing the output data sets is adapted to compared the output data sets with data sets obtained from pre-determined sounds to aid identification.

The invention will now be described by way of example, with reference to the Figures in which:

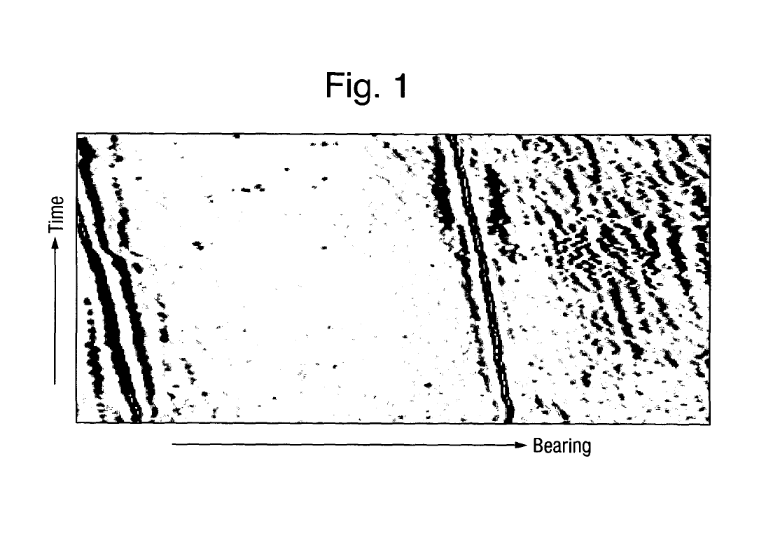

FIG. 1 is typical broadband sonar image obtained from a broadband passive sonar showing a line marking along bearing and time.

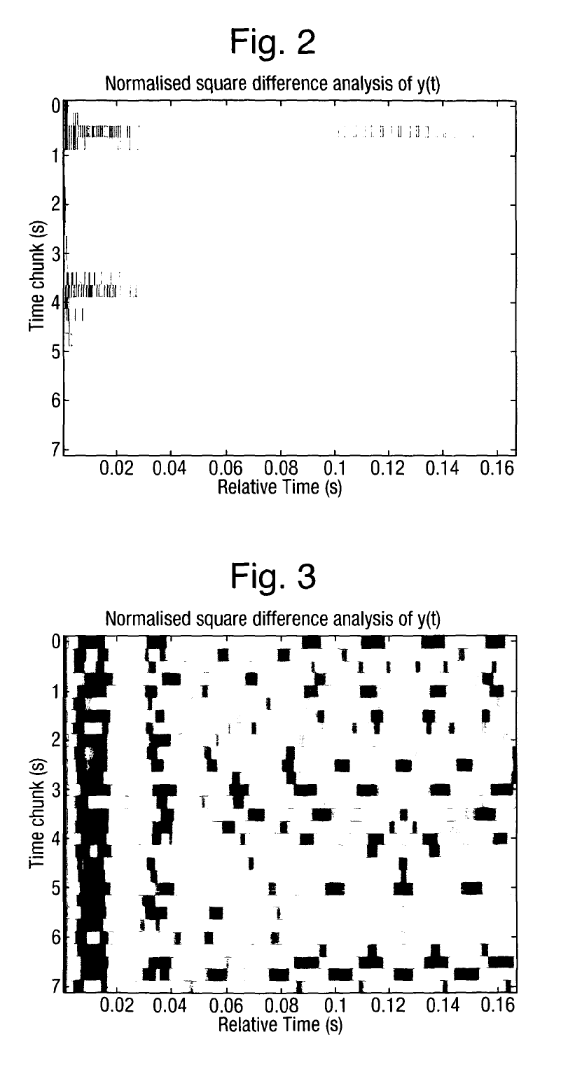

FIG. 2 is a visual representation of the output obtained from a NSDF performed on a sound event, known to be mammal noise (as detected by passive sonar)

FIG. 3 provides a comparative image to that shown in FIG. 2, which demonstrates the output from NSDF applied to a sound event known to be ship noise (as detected by passive sonar).

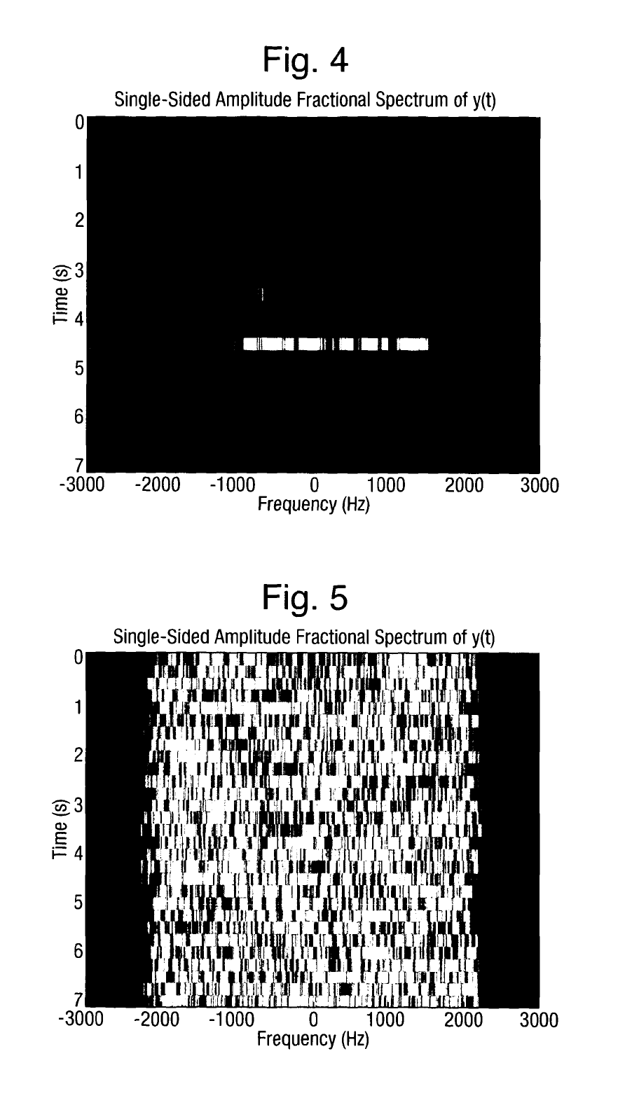

FIG. 4 shows the output obtained after Fractional Fourier Analysis has been performed on the same data set as that shown in FIG. 2 i,e. collected sonar data showing marine mammal noise.

FIG. 5 shows the output of Fractional Fourier analysis of ship noise

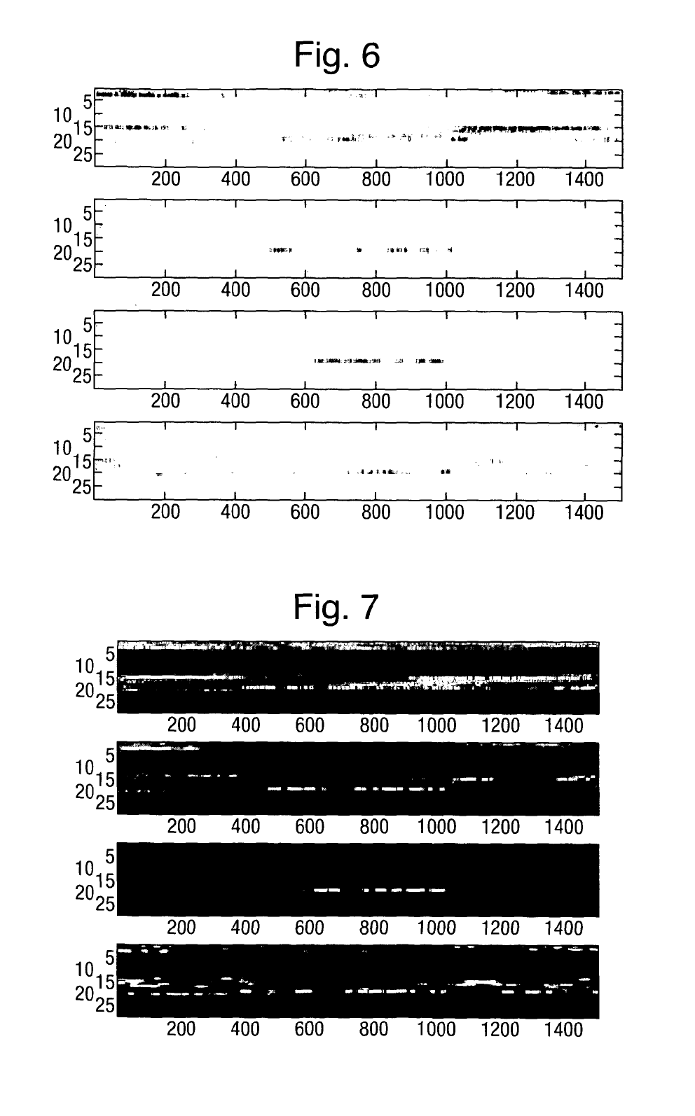

FIG. 6 shows the IMFs of EMD obtained from the sonar data collected from mammal noise 9 (i.e. produced from the same collected data as in the above Figures)

FIG. 7 shows the Hilbert analysis of the IMFs shown in FIG. 6.

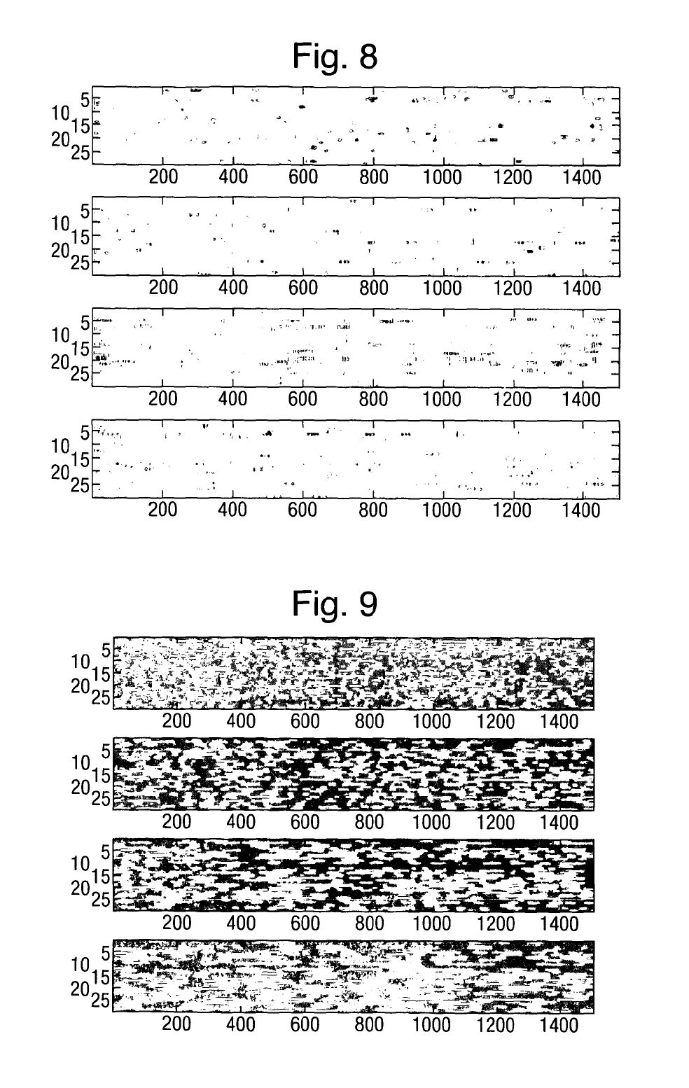

FIG. 8 shows the IMFS of EMD performed on the ship noise data set.

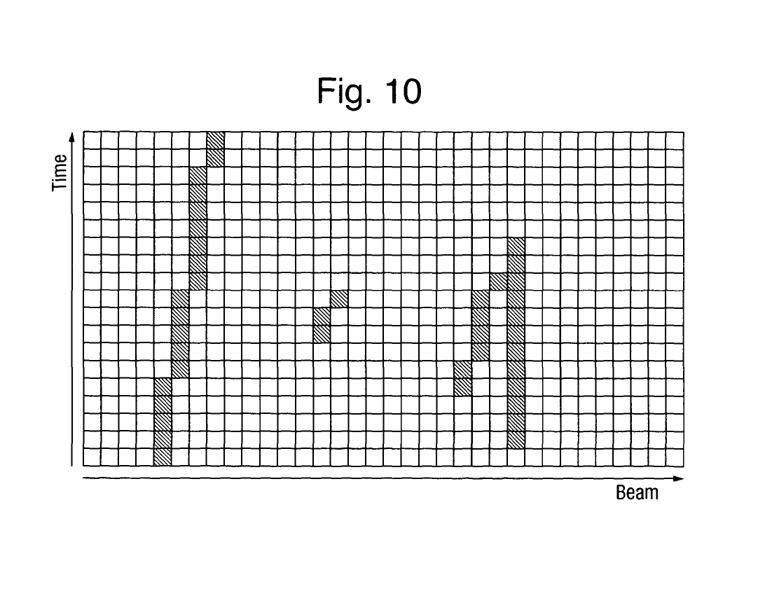

FIG. 9 shows the result of Hilbert analysis of IMFs of ship noise.

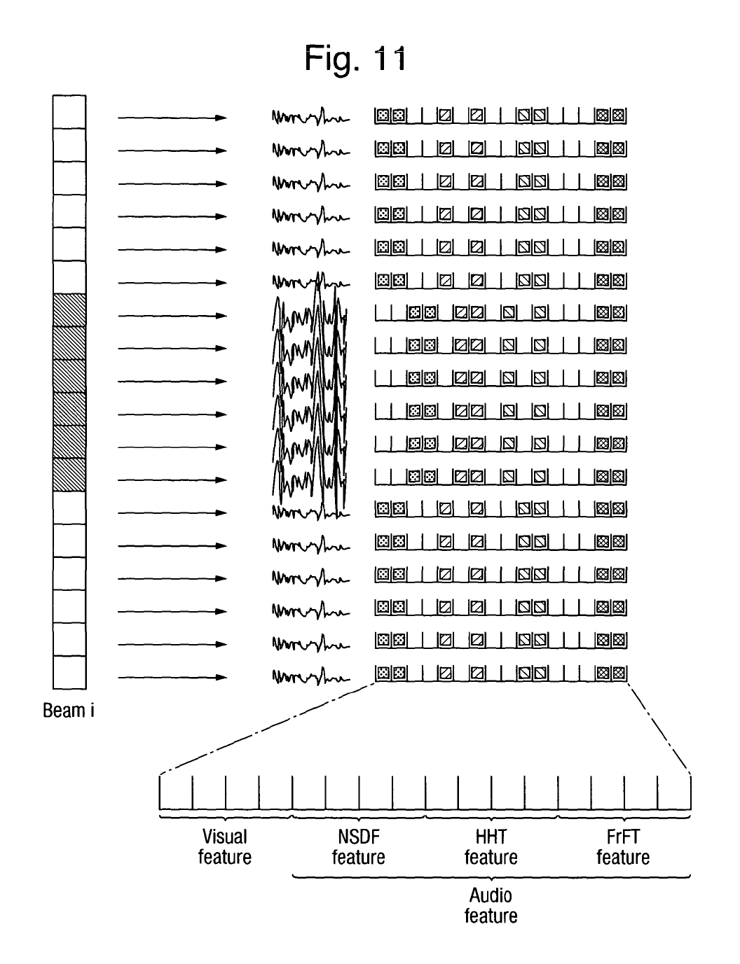

FIG. 10 shows a schematic view of the visual data obtained from a broadband passive sonar, in a time vs beam plot.

FIG. 11 demonstrates a method of comparing output data produced by the parallel processing of the collected data (based on those features shown in FIG. 10)

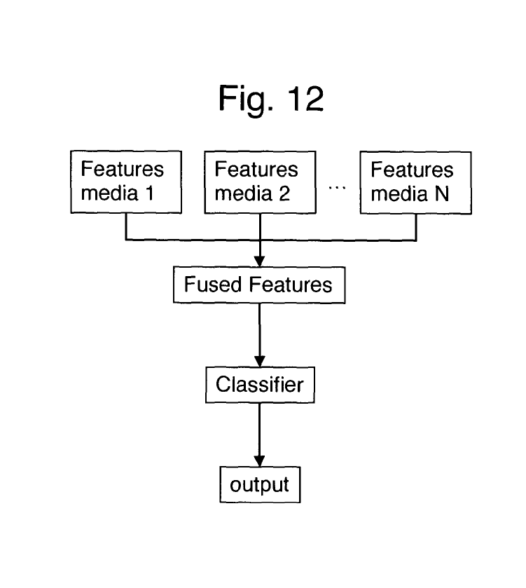

FIG. 12 is a schematic showing a possible concept for the early integration of auditory-visual data for comparing the output data sets of the method of the invention and for providing an output or ultimate categorisation of the collected data signal as being mechanical, biological or environmental.

### EXAMPLE

### Discrimination Between Marine Mammal Noise with Frequency Modulated Chirps and Ship Noise with a Regular Rhythm

Two data sets were obtained and used to illustrate the relative response of the three different algorithms:
Marine mammal noise with frequency modulated chirps;
Ship noise with a regular rhythm.
   Such audio outputs from a sonar detector are normally collected and displayed visually as a broadband passive sonar image, in which features are mapped as bearing against time. An example of such a broadband sonar image is shown in FIG. 1. Identification of features in such an image would normally be undertaken by the sonar operator selecting an appropriate time/bearing and listening to the sound measured at that point in order to classify it as man-made or biological. The approach adopted in this experiment was to divide the time series data into regular “chunks” and then apply the algorithms to each chunk. The output of the algorithm can then be plotted as an output level as a function of time or frequency for each chunk.

FIGS. 2-9 show the output from applying the different algorithms to each type of data. As expected, the output from the NSDF analysis of the ship noise (FIG. 3) shows a clear persistent feature as a vertical line at 0.023 seconds corresponding to the rhythmic nature of the noise. In contrast, the NSDF analysis of marine mammal noise (FIG. 2) has no similar features.

As expected the Fractional Fourier analysis of marine mammal noise (FIG. 4) shows a clear feature as a horizontal line at 4.5 seconds. In contrast, the Fractional Fourier analysis of ship noise (FIG. 5) shows no similar features.

FIGS. 6 & 8 show the intrinsic mode functions (IMFs) from the Empirical Mode Decomposition (EMD) of each time chunk. In each figure the top panel is the original time series, the upper middle panel is the high frequency components with progressively lower frequency components in the lower middle and bottom panels. FIGS. 7 & 9 show the Hilbert analysis of the IMFs from FIGS. 6 & 8 respectively.

The HHT analysis of marine mammal noise (FIGS. 6 & 7) shows clear horizontal line features, whereas the HHT analysis of ship noise (FIGS. 8 & 9) shows no similar features. Unlike the FrFT approach, the HHT algorithm does not require the pulses to have regular modulation. Hence the HHT algorithm would be expected to work against impulsive clicks as well as organised pulses.

### Results From Audio Signal Analysis

Publicly sourced sonar data has been acquired to exemplify the process with which the audio-visual data is analysed and subsequently compared to enable a classification of the sound event as being mechanical, biological or environmental. In this example, the extraction of salient features is demonstrated but it is understood that the same process could be applied to each data source immediately after collection to provide real-time analysis or as close to real time processing as is possible within the data collection rate.

In practice and in a very simplistic manner, a single source of data collected from the acoustic sensor (in this case a passive sonar) is either visualised in a time vs. beam plot of the demodulated signal (demon plot) as shown in FIG. 10 or a continuous audio stream for each beam. Each pixel of the image is a compressed value of a portion of signal in a beam. In the visual data, tracks will appear in the presence of ships, boats or biological activity. These tracks are easily extracted and followed using conventional image processing techniques. From these techniques, visual features can be extracted. For each pixel, a portion of the corresponding audio data in the corresponding beam is analysed using the NSDF, the Hilbert Huang transform and the Fractional Fourier approach.

The processing approach taken is schematised in FIG. 11. For each pixel in a given beam, the audio signal is extracted. Features for the pixel are stored in a feature vector as well as the features extracted from the portion of time series corresponding to various analyses (NSDF, HHT and FrFT). Some features may strengthen depending on the content of the signal. Certain features will be activated or not depending on their strength and this activation will indicate into which category an event is more probable to fall into biological or mechanical. A similar approach can be followed to identify environmental sound events.

### Feature Analysis and Integration

The method using three analysis techniques has been presented from which classifying features can be extracted. Once the pertinent features have been extracted an processed as above, a simple comparison can take place to identify the source of the noise event.

Once the features from each of the algorithms has been established, they can be combined or fused together into a set of combined features and used to characterise the source of the noise using audio and visual information. This may be thought of as an “early integration” concept for collecting, extracting and fusing the collected data, in order to combine audio and visual data to determine the source of a particular sound.

A schematic of such an early integration audio-visual concept is shown in FIG. 12.

1. A method for the detection and identification of a sound event comprising;
collecting audio data from an acoustic sensor;
processing the collected audio data to determine periodicity of the sound, processing the collected audio data to isolate transient and/or non-linear sounds and processing the collected audio data to identify frequency modulated pulses, in parallel to produce three output data sets; and
combining and comparing the output data sets to categorise the sound event as being mechanical, biological or environmental.

2. A method according to claim 1 in which the audio data is collected from an array of acoustic sensors.

3. A method according to claim 1 wherein the acoustic sensor is a passive acoustic sensor.

4. A method according to claim 3 wherein the acoustic sensor is a hydrophone, a microphone, a geophone or an ionophone.

5. A method according to claim 4 wherein the acoustic sensor is a hydrophone.

6. A method according to claim 1 wherein the acoustic sensor operates in the frequency range of from about 1.5 kHz to 16 kHz, preferably in the range of from about 2 to 12 kHz and more preferably from about 3 to 6 kHz.

7. A method according to claim 1 wherein the periodicity of the sound is determined by subjecting the collected audio data to Normalised Square Difference Function.

8. A method according to claim 1 wherein transient and/or non-linear sounds are determined by applying a Hilbert-Huang Transform to the collected audio data.

9. A method according to claim 1 wherein frequency modulated pulses are determined by applying a Fractional Fourier Transform to the collected audio data.

10. A method according to claim 1 wherein the combined output data sets are compared with data sets obtained from pre-determined sound events.

11. An apparatus for the detection and identification of a sound event comprising:
an acoustic sensor;
means for collecting audio data from the acoustic sensor;
processing means adapted for parallel processing of the collected audio data to determine periodicity of the sound, to isolate transient and/or non-linear sounds and to identify frequency modulated pulses, to produce output data sets;
means for combining and comparing the output data sets; and
display means for displaying and distinguishing the output data sets and the collected audio data.

12. An apparatus according to claim 11 which comprises an array of acoustic sensors.

13. An apparatus according to claim 11 wherein the acoustic sensor is a passive acoustic sensor.

14. An apparatus according to claim 13 wherein the acoustic sensor is a hydrophone, a microphone, a geophone or an ionophone.

15. An apparatus according to claim 14 wherein the acoustic sensor is a hydrophone.

16. An apparatus according to claim 11 wherein the acoustic sensor operates in the frequency range of from about 1.5 kHz to 16 kHz, preferably in the range of from about 2 to 12 kHz and more preferably from about 3 to 6 kHz.

17. An apparatus according to claim 11 wherein the means for collecting audio data is an analogue to digital converter.

18. An apparatus according to claim 11 wherein the periodicity of the sound is determined by subjecting the collected audio data to Normalised Square Difference Function.

19. An apparatus according to claim 11 wherein transient and/or nonlinear sounds are determined by applying a Hilbert-Huang Transform to the collected audio data.

20. An apparatus according to claim 11 wherein frequency modulated pulses are determined by applying a Fractional Fourier Transform to the collected audio data.

21. An apparatus according to claim 11 wherein the means for combining and comparing the output data sets is adapted to compared the output data sets with data sets obtained from pre-determined sounds to aid identification.
